(19) United States
(12) Patent Application Publication
(10) Pub. No.: US 2021/0016803 A1
(43) Pub. Date: Jan. 21, 2021

(54) AUTONOMOUS DRIVING OPERATION PLANNING APPARATUS, AUTONOMOUS DRIVING OPERATION PLANNING METHOD, AND AUTONOMOUS DRIVING OPERATION PLANNING PROGRAM

(71) Applicant: DENSO CORPORATION, Kariya-city (JP)

(72) Inventors: Masatake ISHIKAWA, Kariya-city (JP); Katsuyuki MORI, Kariya-city (JP)

(21) Appl. No.: 16/931,877

(22) Filed: Jul. 17, 2020

(30) Foreign Application Priority Data
Jul. 19, 2019 (JP) 2019-133441

(51) Int. Cl. B60W 60/00; B60W 40/105; G01C 21/34

(52) U.S. Cl. CPC B60W 60/0025; B60W 2520/00; G01C 21/3415; B60W 40/105

(57) ABSTRACT

An autonomous driving operation planning apparatus for generating an autonomous driving operation plan includes: an operation plan generator generating an operation plan by autonomous driving of the vehicle; a controller controlling the vehicle by autonomous driving based on the operation plan; a data receiver receiving support information for the autonomous driving from an external terminal by communication; and a delay time calculator calculating a delay time of the communication. If the calculated delay time is equal to or more than a predetermined threshold value, the operation plan generator sets a vehicle speed limit value indicating an upper limit of a speed of the vehicle in such a manner that the vehicle speed limit value becomes smaller as the delay time is longer and that the vehicle speed limit value becomes smaller with a larger change rate as the delay time is longer, and generates the operation plan.

### CROSS-REFERENCE TO RELATED APPLICATION

This application is based on and claims the benefit of priority from earlier Japanese Patent Application No. 2019-133441 filed Jul. 19, 2019, the description of which is incorporated herein by reference.

### BACKGROUND

### Technical Field

The present disclosure relates to an autonomous driving operation planning apparatus, an autonomous driving operation planning method, and an autonomous driving operation planning program.

### Description of the Related Art

In the field of autonomous driving, a technique has been proposed in which autonomous driving is performed via a network such as wireless communication. In the autonomous driving technique, a problem arises in the autonomous driving operation if a communication delay occurs.

### SUMMARY

An autonomous driving operation planning apparatus according to the present disclosure is an autonomous driving operation planning apparatus mounted on a vehicle for generating an autonomous driving operation plan and includes: an operation plan generator configured to generate an operation plan by autonomous driving of the vehicle; a controller configured to control the vehicle by autonomous driving on a basis of the operation plan generated by the operation plan generator; a data receiver configured to receive support information for the autonomous driving of the vehicle from an external terminal by communication; and a delay time calculator configured to calculate a delay time of communication between the external terminal and the data receiver.

### BRIEF DESCRIPTION OF THE DRAWINGS

In the accompanying drawings:

FIG. 1 is an image diagram illustrating a risk when a communication delay occurs;

FIG. 2 is a block diagram illustrating a schematic configuration of a computer that functions as an autonomous driving operation planning apparatus according to the present disclosure;

FIG. 3 is a block diagram illustrating a configuration of an autonomous driving operation planning apparatus according to a first embodiment;

FIG. 4 is an image diagram illustrating a relation among an operator monitoring distance, a delay distance, and a safety margin;

FIG. 5 is a graph illustrating an example of a relation between a travelable distance and a delay time;

FIG. 6 is a graph illustrating an example of the relation between a deceleration and a delay time;

FIG. 7 is a graph illustrating an example of a relation between a vehicle speed limit value and a delay time;

FIG. 8 is an image diagram illustrating an example of setting a plurality of safety margins;

FIG. 9 is a graph illustrating an example of a relation between a vehicle speed limit value and a delay time;

FIG. 10 is a flowchart illustrating an autonomous driving operation plan process routine of the autonomous driving operation planning apparatus according to the first embodiment;

FIG. 11 is a flowchart illustrating a vehicle speed limit value calculation process routine of the autonomous driving operation planning apparatus according to the first embodiment;

FIG. 12 is a flowchart illustrating a safety margin setting process routine of the autonomous driving operation planning apparatus according to the first embodiment;

FIG. 13 is a block diagram illustrating a functional configuration of an autonomous driving center according to a second embodiment;

FIG. 14 is a flowchart illustrating an autonomous driving operation plan process routine of an autonomous driving operation planning apparatus according to the second embodiment;

FIG. 15 is a block diagram illustrating a functional configuration of an autonomous driving center according to a third embodiment;

FIG. 16 is a flowchart illustrating an autonomous driving operation plan process routine of an autonomous driving operation planning apparatus according to the third embodiment;

FIG. 17 is a block diagram illustrating a functional configuration of an autonomous driving center according to a fourth embodiment;

FIG. 18 is a graph illustrating an example of a relation between a vehicle speed limit value and a delay time;

FIG. 19 is a flowchart illustrating an autonomous driving operation plan process routine of an autonomous driving operation planning apparatus according to the fourth embodiment;

FIG. 20 is a block diagram illustrating a functional configuration of an autonomous driving center according to a fifth embodiment;

FIG. 21 is a flowchart illustrating an autonomous driving operation plan process routine of an autonomous driving operation planning apparatus according to the fifth embodiment;

FIG. 22 is a flowchart illustrating a vehicle speed limit value calculation process routine of the autonomous driving operation planning apparatus according to the fifth embodiment;

FIG. 23 is a block diagram illustrating a functional configuration of an autonomous driving center according to a sixth embodiment;

FIG. 24 is a flowchart illustrating an autonomous driving operation plan process routine of an autonomous driving operation planning apparatus according to the sixth embodiment;

FIG. 25 is a block diagram illustrating a functional configuration of an autonomous driving center according to a seventh embodiment;

FIG. 26 is a flowchart illustrating an autonomous driving operation plan process routine of an autonomous driving operation planning apparatus according to the seventh embodiment; and

FIG. 27 is a flowchart illustrating a safety margin setting process routine of an autonomous driving operation planning apparatus according to another example.

### DETAILED DESCRIPTION OF THE PREFERRED EMBODIMENTS

In the autonomous driving technique, as a conventional art, for example, Japanese Patent Application Laid-Open Publication No. 2017-204152 discloses a technique in which when autonomous driving is performed via a network such as wireless communication, if a communication delay occurs, a driver is alerted to enhance safety such as avoiding collision with another vehicle. However, since the technique of the above-described patent literature is merely an alert to the driver, if external support information is delayed, especially when an operator assists in a scene that cannot be determined by sensing, vehicle control may be delayed due to the delay. Therefore, there is a problem that, when external support occurs, even if the conventional technique is applied, there is a risk of collision with another vehicle.

Hereinafter, embodiments of the present disclosure will be described with the use of the drawings.

### <Outline of Autonomous Driving Operation Planning Apparatus According to Present Disclosure>

First, the outline of the present disclosure will be described.

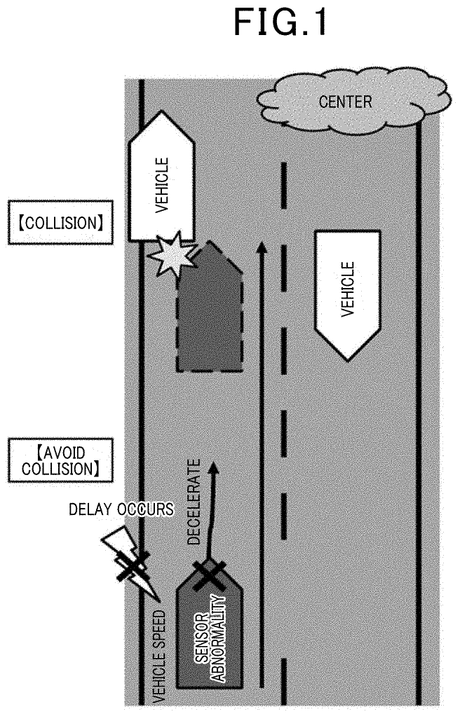

When a communication delay occurs during operator support in a scene that cannot be determined by sensing, if a vehicle is driven by autonomous driving at a current vehicle speed, there is a risk of collision with a vehicle ahead caused by the delay in vehicle control due to the delay (FIG. 1). In addition, the operator side of external support will also be liable if there is an accident due to an unintended operation of the vehicle.

Therefore, in the present disclosure, by limiting (decelerating) the vehicle speed of an autonomous vehicle in accordance with a communication delay time, a situation where an own vehicle collides with another vehicle or the like is avoided. With such a configuration, even if there is a communication delay in autonomous driving with external support, highly safe autonomous driving can be achieved.

### <Configuration of Autonomous Driving Operation Planning Apparatus According to First Embodiment of Present Disclosure>

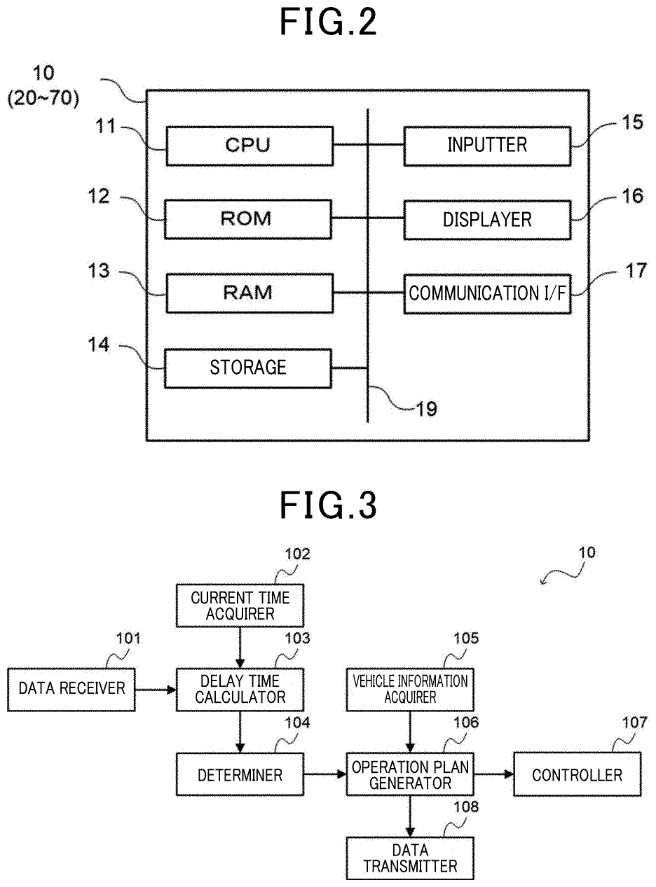

The configuration of an autonomous driving operation planning apparatus 10 according to the embodiment of the present disclosure will be described with reference to FIGS. 2 and 3. FIG. 2 is a block diagram illustrating a hardware configuration of the autonomous driving operation planning apparatus 10 according to the present embodiment. As illustrated in FIG. 2, the autonomous driving operation planning apparatus 10 includes a CPU (Central Processing Unit) 11, a ROM (Read Only Memory) 12, a RAM (Random Access Memory) 13, a storage 14, an input unit 15, a displayer 16, and a communication interface (I/F) 17. The respective components are communicably connected with one another via a bus 19.

The CPU 11 is a central processing unit and executes various programs and controls each component. That is, the CPU 11 reads a program from the ROM 12 or the storage 14 and executes the program with the use of the RAM 13 as a work area. The CPU 11 controls the abovementioned each component and performs various arithmetic processes in accordance with the program stored in the ROM 12 or the storage 14. In the present embodiment, the ROM 12 or the storage 14 stores an autonomous driving operation plan program for performing an autonomous driving operation plan process, a vehicle speed limit value calculation process, and a safety margin setting process.

The ROM 12 stores various programs and various data. The RAM 13 temporarily stores a program or data as a work area. The storage 14 includes an HDD (Hard Disk Drive) or an SSD (Solid State Drive), and stores various programs including an operating system and various data.

The input unit 15 includes a pointing device such as a mouse and a keyboard, and is used to perform various inputs.

The displayer 16 is, for example, a liquid crystal display, and displays various information. The displayer 16 may employ a touch panel method and function as the input unit 15.

The communication I/F 17 is an interface for communicating with another device, and for example, a standard such as Ethernet (registered trademark), FDDI, or Wi-Fi (registered trademark) is used. Specifically, the communication interface 17 is connected to a device such as a communication antenna or a wireless router mounted on a vehicle for performing wireless communication, and is implemented so as to perform wireless communication. In addition, the communication interface 17 may be configured to include a wireless communication antenna in such a manner that the autonomous driving operation planning apparatus 10 per se can perform wireless communication.

Next, the functional configuration of the autonomous driving operation planning apparatus 10 will be described. FIG. 3 is a block diagram illustrating an example of the functional configuration of the autonomous driving operation planning apparatus 10. As illustrated in FIG. 3, the autonomous driving operation planning apparatus 10 according to the present embodiment includes a data receiver 101, a current time acquirer 102, a delay time calculator 103, a determiner 104, a vehicle information acquirer 105, an operation plan generator 106, a controller 107, and a data transmitter 108.

The data receiver 101 receives support information for the autonomous driving of a vehicle from an external terminal by communication. The external terminal is an autonomous driving center that transmits the support information to the vehicle or is a vehicle in the vicinity. In the present disclosure, unless otherwise specified, a case where the external terminal is an autonomous driving center will be described as an example. Then, the data receiver 101 transfers the received support information to the delay time calculator 103.

The current time acquirer 102 acquires a current time. Specifically, the current time acquirer 102 acquires a current time from a timer (not illustrated) mounted on the vehicle. Then, the current time acquirer 102 transfers the acquired current time to the delay time calculator 103. The delay time calculator 103 calculates a delay time of communication between the external terminal and the data receiver 101. Specifically, the delay time calculator 103 first extracts a transmission time included in the support information received by the data receiver 101. For example, when the support information is divided into packets in data communication, the delay time calculator 103 extracts a transmission time included in the packets. Next, the delay time calculator 103 calculates a difference between the current time received from the current time acquirer 102 and the extracted transmission time, and sets the calculated value as a delay time t[s]. Then, the delay time calculator 103 transfers the calculated delay time t to the determiner 104.

The determiner 104 determines whether the delay time calculated by the delay time calculator 103 is equal to or more than a predetermined threshold value. If the delay time is equal to or more than the predetermined threshold value, the determiner 104 determines that a communication delay has occurred, and if the delay time is not equal to or more than the predetermined threshold value, the determiner 104 determines that a communication delay has not occurred. When determining that a communication delay has occurred, the determiner 104 transfers a determination result and the delay time t to the operation plan generator 106. On the other hand, when determining that a communication delay has not occurred, the determiner 104 transfers the determination result to the operation plan generator 106.

The vehicle information acquirer 105 acquires a vehicle speed V₀. Specifically, the vehicle information acquirer 105 acquires a current vehicle speed V₀ [m/s] from a vehicle speedometer (not illustrated) mounted on the vehicle. Then, the vehicle information acquirer 105 transfers the acquired vehicle speed V₀ to the operation plan generator 106.

The operation plan generator 106 generates an operation plan by autonomous driving of the vehicle. Specifically, if the determiner 104 determines that a communication delay has occurred, the operation plan generator 106 sets a vehicle speed limit value _{Limit}V₍ₜ₎ indicating an upper limit of a speed of the vehicle in such a manner that the vehicle speed limit value _{Limit}V₍ₜ₎ becomes smaller as the delay time t is longer and that the vehicle speed limit value _{Limit}V₍ₜ₎ becomes smaller with a larger change rate as the delay time t is longer, and generates an operation plan.

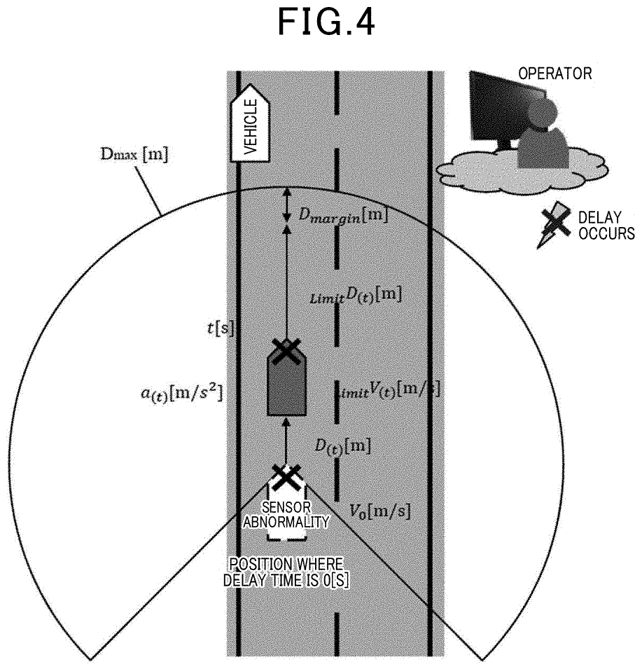

More specifically, if receiving the determination result that a communication delay has occurred from the determiner 104, the operation plan generator 106 calculates a travelable distance _{Limit}D₍ₜ₎ that the vehicle can travel safely on the basis of an operator monitoring distance Dₘₐₓ that is a distance where the vehicle can be monitored by an external terminal such as an autonomous driving support center, a delay distance D₍ₜ₎ that is a distance traveled by the vehicle during the delay time, and a safety margin D_{margin}. FIG. 4 illustrates a relation among the operator monitoring distance Dₘₐₓ, delay distance D₍ₜ₎, and safety margin D_{margin}. As illustrated in FIG. 4, the delay distance D₍ₜ₎ represents a distance moved from a position where there is no communication delay, that is, when the delay time is 0 [s] during a time when the communication delay occurs. The operation plan generator 106 calculates the travelable distance _{Limit}D₍ₜ₎ with the use of the following formula (1).

[Math. 1]

_{Limit}D₍ₜ₎=Dₘₐₓ−V₀*t−D_{margin} (1)

That is, as illustrated in FIG. 5, the travelable distance _{Limit}D₍ₜ₎ becomes shorter as the delay time becomes longer.

Next, the operation plan generator 106 calculates a deceleration value a₍ₜ₎ for stopping within the travelable distance _{Limit}D₍ₜ₎ on the basis of the calculated travelable distance _{Limit}D₍ₜ₎ and the vehicle speed V₀ acquired by the vehicle information acquirer 105, with the use of the following formula (2).

$$\begin{matrix}[ Math . 2 ] & \\ {a}_{( t )} = \frac{- {V}_{0}^{2}}{2 * {LimitD}_{( t )}} & ( 2 )\end{matrix}$$

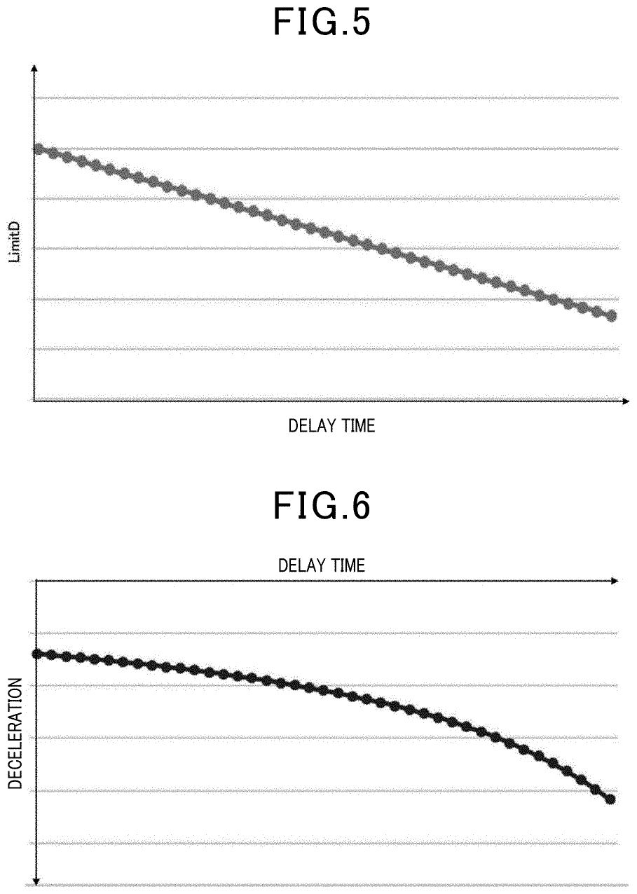

That is, as illustrated in FIG. 6, the deceleration value a₍ₜ₎ becomes a smaller value (a larger value in the negative direction) as the delay time becomes longer. That is, the longer the delay time is, the less monitoring is performed, and thus the risk on the vehicle increases. In this case, since the vehicle speed V₀ needs to be greatly reduced, the deceleration value a₍ₜ₎ is set to a small value.

Next, the operation plan generator 106 calculates the vehicle speed limit value _{Limit}V₍ₜ₎ on the basis of the calculated deceleration value a₍ₜ₎ and the vehicle speed V₀, with the use of the following formula (3).

[Math. 3]

_{Limit}V₍ₜ₎=V₀+a₍ₜ₎*t (3)

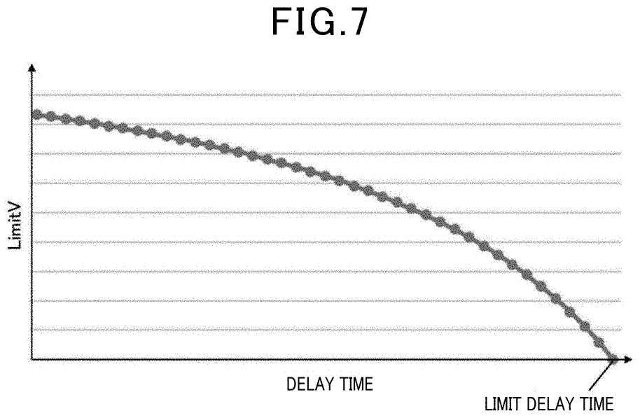

Next, the operation plan generator 106 generates an operation plan including a speed and an acceleration at each time with the calculated vehicle speed limit value _{Limit}V₍ₜ₎ as the upper limit. As illustrated in FIG. 7, according to the generated operation plan, the longer the delay time, the smaller the value of the vehicle speed limit value _{Limit}V₍ₜ₎ can be made. That is, the vehicle speed can be limited to a safe speed. In addition, in FIG. 7, a limit delay time is a delay time such that the travelable distance _{Limit}D₍ₜ₎ becomes 0 or less, and in this case, the operation plan generator 106 generates an operation plan for stopping the vehicle.

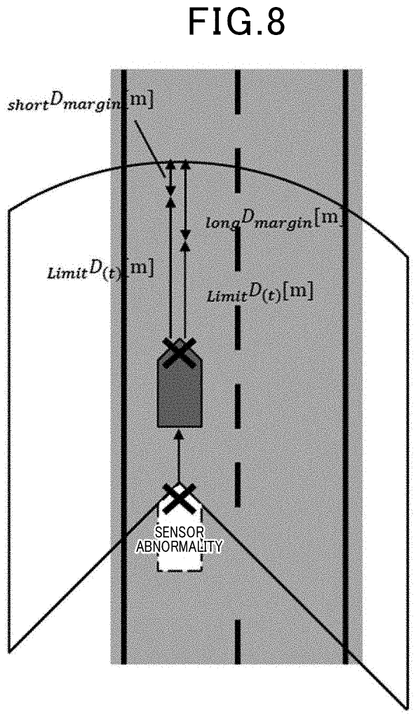

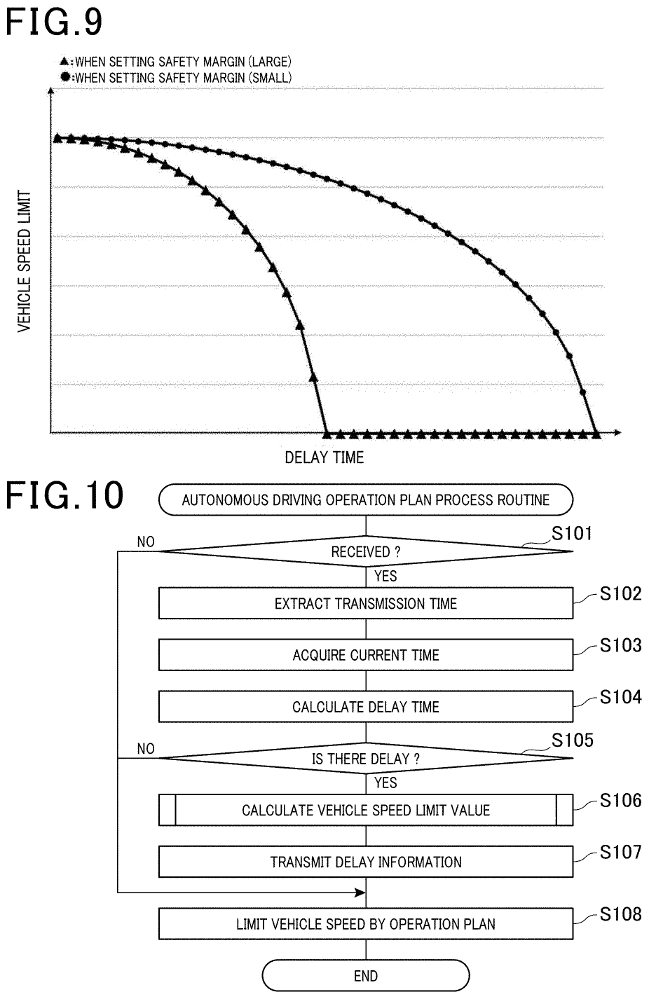

Here, the safety margin D_{margin} may be predetermined or set by the operation plan generator 106. When set by the operation plan generator 106, the safety margin may be configured in such a manner that a plurality of safety margins D_{margin} are determined in accordance with whether the support information includes data related to control of autonomous driving, whether a communication cycle is long or short, the vehicle speed V₀, and the condition of a travel route. For example, the operation plan generator 106 may be configured to set a large safety margin _{long}D_{margin} when the support information includes data related to control of autonomous driving, and set a small safety margin ₛₕₒᵣₜD_{margin} when the support information does not include data related to control of autonomous driving. This is because it is highly necessary to ensure safety when the support information includes information related to control of autonomous driving. In this case, as illustrated in FIG. 8, two safety margins D_{margin}, that are a large safety margin _{long}D_{margin} and a small safety margin ₛₕₒᵣₜD_{margin} are set. The large safety margin _{long}D_{margin} is larger than the small safety margin ₛₕₒᵣₜD_{margin}. For example, the small safety margin ₛₕₒᵣₜD_{margin}may be set to the same value as a predetermined safety margin D_{margin}, and the margin, large safety margin _{long}D_{margin} may be set to a value larger than the predetermined safety margin D_{margin}. In this case, as illustrated in FIG. 9, when the large safety margin _{long}D_{margin} is set, the longer the delay time t is, the smaller the vehicle speed limit value _{Limit}V₍ₜ₎ becomes with a larger change rate than when the small safety margin ₛₕₒᵣₜD_{margin} is set.

On the other hand, when the determiner 104 determines that a communication delay has not occurred, the operation plan generator 106 generates a normal operation plan or an operation plan for performing autonomous driving based on the support information received from the external terminal.

Then, the operation plan generator 106 transfers the generated operation plan to the controller 107. In addition, the operation plan generator 106 transfers delay information including the vehicle speed limit value _{Limit}V₍ₜ₎ and the delay time t to the data transmitter 108.

The controller 107 controls the vehicle by autonomous driving on the basis of the operation plan generated by the operation plan generator 106. Specifically, the controller 107 controls the traveling of the vehicle in accordance with the speed and the acceleration at each time included in the operation plan. Every time receiving the operation plan generated by the operation plan generator 106, the controller 107 controls the vehicle on the basis of a latest operation plan.

The data transmitter 108 transmits the delay information to the external terminal.

### <Action of Autonomous Driving Operation Planning Apparatus According to First Embodiment of Present Disclosure>

FIG. 10 is a flowchart illustrating an autonomous driving operation plan process routine according to the embodiment of the present disclosure. Every time a predetermined time elapses, the autonomous driving operation planning apparatus 10 executes the autonomous driving operation plan process routine illustrated in FIG. 10.

First, in step S101, the data receiver 101 determines whether support information for the autonomous driving of a vehicle has been received from an external terminal by communication.

If the support information has not been received (NO in step S101 above), the process proceeds to step S108.

On the other hand, if the support information has been received (YES in step S101), in step S102, the delay time calculator 103 extracts a transmission time included in the support information received in step S101 above.

In step S103, the current time acquirer 102 acquires a current time.

In step S104, the delay time calculator 103 calculates a delay time of communication between the external terminal and the data receiver 101.

In step S105, if the delay time calculated in step S104 above is equal to or more than a predetermined threshold value, the determiner 104 determines that a communication delay has occurred, and if not so, the determiner 104 determines that a communication delay has not occurred.

If no communication delay has occurred (NO in step S105 above), the process proceeds to step S108.

On the other hand, if a communication delay has occurred (YES in step S105 above), the operation plan generator 106 executes a vehicle speed limit value calculation process in step S106.

In step S107, the controller 107 controls the vehicle on the basis of the operation plan generated in step S106 above.

In step S108, the data transmitter 108 transmits the delay information to the external terminal and the process ends. When the predetermined time elapses again, the autonomous driving operation planning apparatus 10 repeats executing an autonomous driving operation plan process routine.

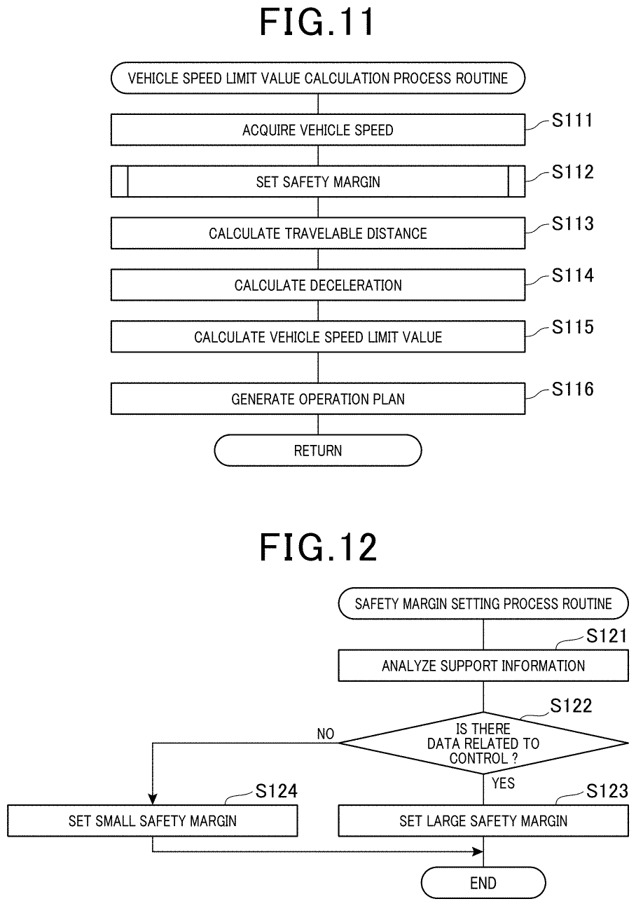

FIG. 11 is a flow chart illustrating a vehicle speed limit value calculation process routine in step S106 above.

In step S111, the vehicle information acquirer 105 acquires a vehicle speed V₀.

In step S112, the operation plan generator 106 performs a safety margin setting process.

In step S113, the operation plan generator 106 calculates a travelable distance _{Limit}D₍ₜ₎ that the vehicle can travel safely on the basis of an operator monitoring distance Dₘₐₓ that is a distance where the vehicle can be monitored by an external terminal such as an autonomous driving support center, a delay distance D₍ₜ₎ that is a distance traveled by the vehicle during the delay time, and a safety margin D_{margin} set in advance.

In step S114, the operation plan generator 106 calculates a deceleration value a₍ₜ₎ for stopping within the travelable distance _{Limit}D₍ₜ₎ on the basis of the calculated travelable distance _{Limit}D₍ₜ₎ and the vehicle speed V₀ acquired in step S111 above.

In step S115, the operation plan generator 106 calculates the vehicle speed limit value _{Limit}V₍ₜ₎ on the basis of the deceleration value a₍ₜ₎ calculated in step S114 above and the vehicle speed V₀.

In step S116, the operation plan generator 106 generates an operation plan including a speed limit based on the vehicle speed limit value _{Limit}V₍ₜ₎ calculated in step S115, and returns.

FIG. 12 is a flow chart illustrating a safety margin setting process routine in step S112 above.

In step S121, the operation plan generator 106 analyzes the data included in the support information received in step S101 above.

In step S122, the operation plan generator 106 determines whether the support information includes data related to control of autonomous driving.

If the support information includes data related to control of autonomous driving (YES in step S122 above), the operation plan generator 106 sets a large safety margin _{long}D_{margin} to the safety margin D_{margin} in step S123.

On the other hand, if the support information does not include data related to control of autonomous driving (NO in step S122 above), the operation plan generator 106 sets a small safety margin ₛₕₒᵣₜD_{margin} to the safety margin D_{margin} in step S124.

As described above, according to the autonomous driving operation planning apparatus of the first embodiment of the present disclosure, support information for autonomous driving of a vehicle is received from an external terminal by communication, and a delay time of communication with the external terminal is calculated. If the calculated delay time is equal to or more than a predetermined threshold value, a vehicle speed limit value indicating an upper limit of a speed of the vehicle is set in such a manner that the vehicle speed limit value becomes smaller as the delay time is longer and that the vehicle speed limit value becomes smaller with a larger change rate as the delay time is longer, and an operation plan is generated. The vehicle is controlled by autonomous driving on the basis of the generated operation plan, and highly safe autonomous driving can be thereby achieved even if there is a communication delay in autonomous driving with external support.

### <Configuration of Autonomous Driving Operation Planning Apparatus According to Second Embodiment of Present Disclosure>

Next, the configuration of an autonomous driving operation planning apparatus 20 according to a second embodiment of the present disclosure will be described. In addition, with regard to the configuration similar to that of the autonomous driving operation planning apparatus 10 according to the first embodiment, the same reference numerals are assigned and detailed description is omitted.

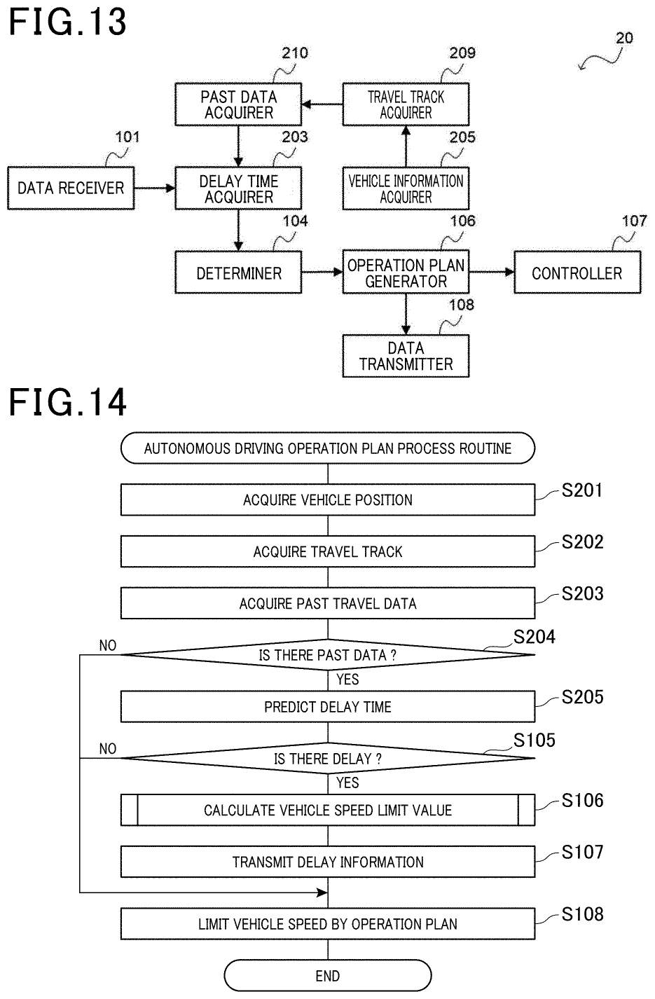

As illustrated in FIG. 13, the autonomous driving operation planning apparatus 20 according to the present embodiment includes the data receiver 101, a delay time acquirer 203, the determiner 104, a vehicle information acquirer 205, the operation plan generator 106, the controller 107, the data transmitter 108, a travel track acquirer 209, and a past data acquirer 210.

The vehicle information acquirer 205 acquires the current position of the vehicle. Specifically, the vehicle information acquirer 205 acquires the current position of the vehicle from a position measuring device (not illustrated) such as a GPS mounted on the vehicle. Then, the vehicle information acquirer 205 transfers the acquired current vehicle position to the travel track acquirer 209.

The travel track acquirer 209 acquires information on a travel route on which the vehicle has traveled. Specifically, the travel track acquirer 209 acquires information on a travel route on which the vehicle has traveled on the basis of the history of the position of the vehicle acquired by the vehicle information acquirer 205 up to the present time. Then, the travel track acquirer 209 transfers the acquired travel route information to the past data acquirer 210.

The past data acquirer 210 acquires past travel data including a delay time of communication between the external terminal and the data receiver 101 during traveling. Specifically, the past data acquirer 210 acquires past travel data corresponding to the travel route information from a past data storage (not illustrated) that is included in the external terminal and that stores past travel data. The external terminal collects the delay information generated in the same manner as that of the autonomous driving operation planning apparatus 10 described in the abovementioned first embodiment, and stores, in the past data storage, travel data including the data of the delay time generated on the travel route. Then, the past data acquirer 210 transfers the travel route information and the acquired past travel data to the delay time acquirer 203.

The delay time acquirer 203 acquires a delay time predicted on the basis of the travel route and past travel data. Specifically, the delay time acquirer 203 determines whether there is past travel data on the travel route. If there is past data on the travel route, the delay time acquirer 203 predicts a delay time on the basis of the past travel data. The delay time acquirer 203 sets the average of the delay times included in the past travel data, as the delay time, for example. Then, the delay time acquirer 203 transfers the calculated delay time to the determiner 104.

### <Action of Autonomous Driving Operation Planning Apparatus According to Second Embodiment of Present Disclosure>

FIG. 14 is a flowchart illustrating an autonomous driving operation plan process routine according to the second embodiment. In addition, with regard to the process similar to that of the autonomous driving operation plan process routine according to the first embodiment, the same reference numerals are assigned and detailed description is omitted.

In step S201, the vehicle information acquirer 205 acquires the current position of the vehicle.

In step S202, the travel track acquirer 209 acquires information on a travel route on which the vehicle has traveled.

In step S203, the past data acquirer 210 acquires past travel data including a delay time of communication between the external terminal and the data receiver 101 during traveling.

In step S204, the delay time acquirer 203 determines whether there is past travel data on the travel route.

If there is past travel data on the travel route (YES in step S204 above), the delay time acquirer 203 predicts a delay time on the basis of the past travel data in step S205, and the process proceeds to step S105.

On the other hand, if there is no past travel data on the travel route (NO in step S204 above), the process proceeds to step S108.

As described above, according to the autonomous driving operation planning apparatus of the second embodiment of the present disclosure, support information for autonomous driving of the vehicle is received from an external terminal by communication, and a delay time predicted on the basis of a travel route on which the vehicle has traveled and past travel data including a delay time of communication with the external terminal during the traveling is acquired. If the delay time is equal to or more than a predetermined threshold value, a vehicle speed limit value indicating an upper limit of a speed of the vehicle is set in such a manner that the vehicle speed limit value becomes smaller as the delay time is longer and that the vehicle speed limit value becomes smaller with a larger change rate as the delay time is longer, and an operation plan is generated. The vehicle is controlled by autonomous driving on the basis of the operation plan, and it is thereby possible to grasp a communication delay caused by a place or time before the communication delay occurs, and generate an operation plan corresponding to the communication delay. Therefore, even if there is a communication delay in autonomous driving with external support, highly safe autonomous driving can be achieved.

### <Configuration of Autonomous Driving Operation Planning Apparatus According to Third Embodiment of Present Disclosure>

Next, the configuration of an autonomous driving operation planning apparatus 30 according to a third embodiment of the present disclosure will be described. In addition, with regard to the configuration similar to that of the autonomous driving operation planning apparatus 10 according to the first embodiment and the autonomous driving operation planning apparatus 20 according to the second embodiment, the same reference numerals are assigned and detailed description is omitted.

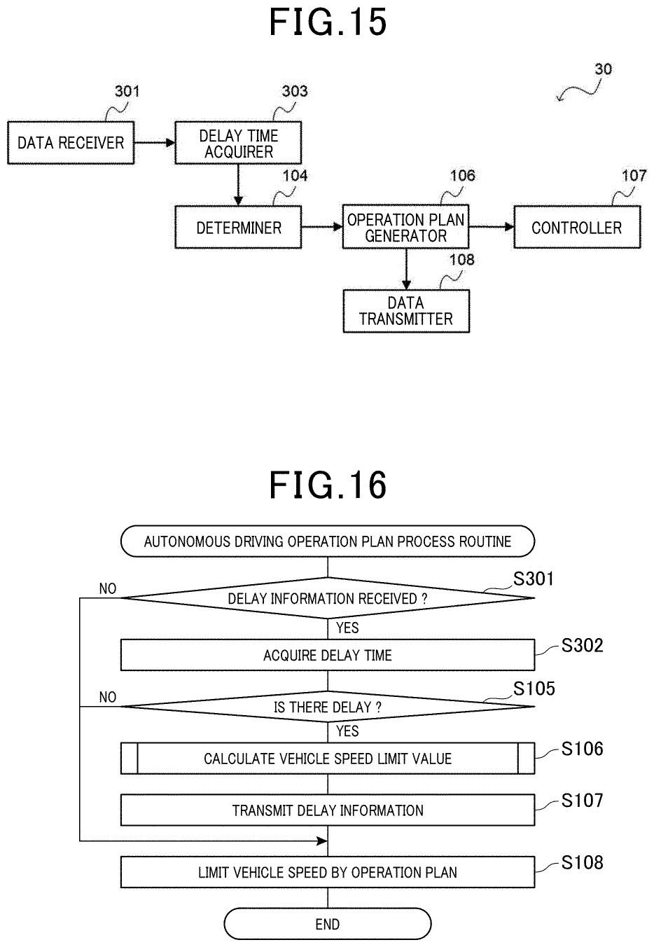

As illustrated in FIG. 15, the autonomous driving operation planning apparatus 30 according to the present embodiment includes a data receiver 301, a delay time acquirer 303, the determiner 104, and the operation plan generator 106, the controller 107, and the data transmitter 108.

In addition, in the third embodiment, the external terminal is a device mounted on another vehicle traveling in front of the vehicle, and is a device that generates delay information in the same manner as that of the autonomous driving operation planning apparatus 10 described in the abovementioned first embodiment.

The data receiver 301 receives a delay time calculated by the external terminal in addition to a process similar to that of the data receiver 101. Specifically, the data receiver 301 receives delay information including a delay time calculated by another vehicle, from the other vehicle which is the external terminal and travels in front of the vehicle. Then, the data receiver 301 transfers the delay information to the delay time acquirer 303.

The delay time acquirer 303 acquires the delay time from the delay information received by the data receiver 301. Then, the delay time acquirer 303 transfers the acquired delay time to the determiner 104.

### <Action of Autonomous Driving Operation Planning Apparatus According to Third Embodiment of Present Disclosure>

FIG. 16 is a flowchart illustrating an autonomous driving operation plan process routine according to the third embodiment. In addition, with regard to the process similar to that of the autonomous driving operation plan process routine according to the first embodiment, the same reference numerals are assigned and detailed description is omitted.

In step S301, the data receiver 301 determines whether the delay information including the delay time calculated by the other vehicle is received.

If the delay information has not been received (NO in step S301 above), the process proceeds to step S108.

On the other hand, if the delay information has been received (YES in step S301 above), the delay time acquirer 303 acquires the delay time from the delay information received by the data receiver 301 in step S302.

As described above, according to the autonomous driving operation planning apparatus of the third embodiment of the present disclosure, delay information including a delay time calculated by another vehicle is received, and the delay time is acquired from the received delay information. If the delay time is equal to or more than a predetermined threshold value, a vehicle speed limit value indicating an upper limit of a speed of the vehicle is set in such a manner that the vehicle speed limit value becomes smaller as the delay time is longer and that the vehicle speed limit value becomes smaller with a larger change rate as the delay time is longer, and an operation plan is generated. The vehicle is controlled by autonomous driving on the basis of the generated operation plan, and it is thereby possible to grasp a communication delay caused by a place or time before the communication delay occurs, and generate an operation plan corresponding to the communication delay. Therefore, even if there is a communication delay in autonomous driving with external support, highly safe autonomous driving can be achieved.

### <Configuration of Autonomous Driving Operation Planning Apparatus According to Fourth Embodiment of Present Disclosure>

Next, the configuration of an autonomous driving operation planning apparatus 40 according to a fourth embodiment of the present disclosure will be described. In addition, with regard to the configuration similar to that of the autonomous driving operation planning apparatus 10 according to the first embodiment, the same reference numerals are assigned and detailed description is omitted.

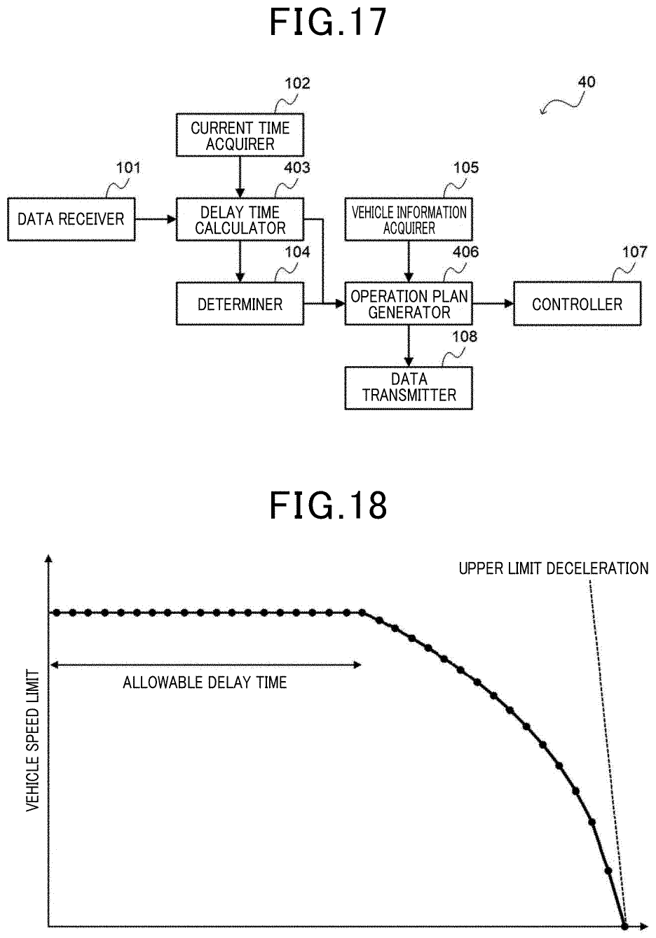

As illustrated in FIG. 17, the autonomous driving operation planning apparatus 40 according to the present embodiment includes the data receiver 101, the current time acquirer 102, a delay time calculator 403, the determiner 104, the vehicle information acquirer 105, an operation plan generator 406, the controller 107, and the data transmitter 108.

The delay time calculator 403 estimates an estimated arrival time at which communication data transmitted from the external terminal arrives, and sets, as a delay time, a difference between a reception time at which the data receiver 101 actually receives the communication data and the estimated arrival time.

Specifically, if the data receiver 101 has not received communication data at a predetermined timing, the delay time calculator 403 determines whether the estimated arrival time at which the communication data arrives can be estimated. For example, there is a case where the arrival time of the next communication data (for example, an IP packet or frame) or the like can be estimated by a known communication method or data delivery method, or the like. When the estimated arrival time cannot be estimated, the delay time calculator 403 does not perform the process until a next predetermined timing. Then, a similar process is performed at the next predetermined timing. On the other hand, when the estimated arrival time can be estimated, the delay time calculator 403 estimates the estimated arrival time. Next, the delay time calculator 403 calculates, as the delay time, the difference between the current time acquired from the current time acquirer 102 and the estimated arrival time. Then, the delay time calculator 403 transfers the calculated delay time to the operation plan generator 406.

In addition to a process similar to that of the operation plan generator 106, the operation plan generator 406 calculates an allowable delay time that can allow a communication delay, and sets the vehicle speed limit value and generates an operation plan if the communication data has not been not received when an elapsed time from the estimated arrival time exceeds the allowable delay time.

Specifically, when the data receiver 101 has not received communication data, the operation plan generator 406 calculates an allowable delay time that can allow a communication delay. The allowable delay time can be determined in advance depending on the communication method and the type of communication data.

Next, the operation plan generator 406 determines whether the delay time which is the elapsed time from the estimated arrival time is within the allowable delay time. If the delay time is within the allowable delay time, the operation plan generator 406 does not perform a process until a next predetermined timing. This is because, if the delay time is within the allowable delay time, it is considered that there is no risk great enough to reduce the vehicle speed. On the other hand, when the delay time is not within the allowable delay time, the vehicle speed limit value _{Limit}V₍ₜ₎ is set on the basis of the delay time, and an operation plan is generated. This is because, if the delay time is not within the allowable delay time, it is considered that there is a risk enough to reduce the vehicle speed. As the elapsed time from the allowable delay time is longer, the risk to the vehicle is higher. Therefore, as illustrated in FIG. 18, the operation plan generator 406 sets the vehicle speed limit value _{Limit}V₍ₜ₎ to be smaller as the elapsed time is longer. Then, the operation plan generator 406 transfers the operation plan to the controller 107.

### <Action of Autonomous Driving Operation Planning Apparatus According to Fourth Embodiment of Present Disclosure>

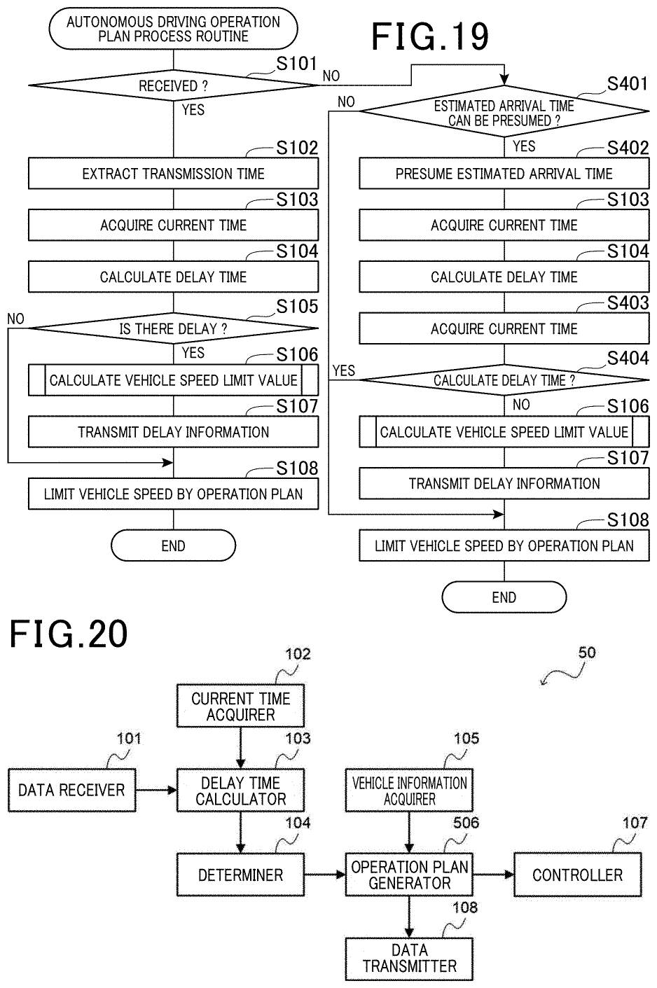

FIG. 19 is a flowchart illustrating an autonomous driving operation plan process routine according to the fourth embodiment. In addition, with regard to the process similar to that of the autonomous driving operation plan process routine according to the first embodiment, the same reference numerals are assigned and detailed description is omitted.

In step S101, if the support information has not been received (NO in step S101 above), the process proceeds to step S401.

In step S401, the delay time calculator 403 determines whether the estimated arrival time at which the communication data arrives can be estimated.

If the estimated arrival time cannot be estimated (NO in step S401 above), the process proceeds to step S108.

On the other hand, when the estimated arrival time can be estimated (YES in step S401 above), the delay time calculator 403 estimates the estimated arrival time in step S402.

In step S403, the operation plan generator 406 calculates an allowable delay time that can allow a communication delay.

In step S404, the operation plan generator 406 determines whether the delay time which is the elapsed time from the estimated arrival time is within the allowable delay time.

If the delay time is within the allowable delay time (YES in step S404 above), the process proceeds to step S106. On the other hand, if the delay time is not within the allowable delay time (NO in step S404 above), the process proceeds to step S108.

As described above, according to the autonomous driving operation planning apparatus of the fourth embodiment of the present disclosure, an estimated arrival time at which communication data transmitted from the external terminal arrives is estimated, a difference between a reception time at which the communication data has been actually received and the estimated arrival time is set as a delay time, and an allowable delay time that can allow a communication delay is calculated. If the communication data has not been not received when an elapsed time from the estimated arrival time exceeds the allowable delay time, a vehicle speed limit value is set and an operation plan is generated. The vehicle is controlled by autonomous driving on the basis of the generated operation plan, and it is thereby possible to generate the operation plan in such a manner that a communication delay due to the place or time can be grasped before the communication delay occurs and the effect on the riding comfort of a passenger can be reduced. Therefore, even if there is a communication delay in autonomous driving with external support, highly safe autonomous driving can be achieved.

### <Configuration of Autonomous Driving Operation Planning Apparatus According to Fifth Embodiment of the Present Disclosure>

Next, the configuration of an autonomous driving operation planning apparatus 50 according to a fifth embodiment of the present disclosure will be described. In addition, with regard to the configuration similar to that of the autonomous driving operation planning apparatus 10 according to the first embodiment, the same reference numerals are assigned and detailed description is omitted.

As illustrated in FIG. 20, the autonomous driving operation planning apparatus 50 according to the present embodiment includes the data receiver 101, the current time acquirer 102, the delay time calculator 103, the determiner 104, the vehicle information acquirer 105, an operation plan generator 506, the controller 107, and the data transmitter 108.

After setting the vehicle speed limit value to be small, if the delay time calculated a plurality of times by the delay time calculator 103 is less than a predetermined threshold value, the operation plan generator 506 sets the vehicle speed limit value _{Limit}V₍ₜ₎ to be large on the basis of the delay time, and generates an operation plan.

Specifically, if the delay time is equal to or more than the predetermined threshold value, the operation plan generator 506 determines that there is a delay and sets a counter c to 0. Note that the initial value of the counter c is set to 0 in advance. Then, the same process as that of the operation plan generator 106 is performed.

On the other hand, if the delay time is less than the predetermined threshold value, the operation plan generator 506 determines whether the vehicle speed is currently limited to the vehicle speed limit value _{Limit}V₍ₜ₎. If there is no vehicle speed limit, the operation plan generator 506 does not perform a process until a next predetermined timing. On the other hand, when there is a vehicle speed limit, the operation plan generator 506 increments the counter c by 1. Next, the operation plan generator 506 determines whether c is larger than a predetermined constant N. When c is larger than N, the operation plan generator 506 sets the vehicle speed limit value _{Limit}V₍ₜ₎ to be large, and generates an operation plan. More specifically, the operation plan generator 506 calculates a value −a₍ₜ₎ obtained by multiplying the deceleration am in the above formula (2) by “−1” (minus 1), and sets the vehicle speed limit value _{Limit}V₍ₜ₎ as is the case with the above formula (3) with the use of the value −a₍ₜ₎. That is, when it is considered that no communication delay has occurred, for N times, it is considered that the communication delay has been recovered, and thus it is possible to generate an operation plan for automatically canceling the vehicle speed limit. Then, the operation plan generator 506 transfers the generated operation plan to the controller 107.

### <Action of Autonomous Driving Operation Planning Apparatus According to Fifth Embodiment of Present Disclosure>

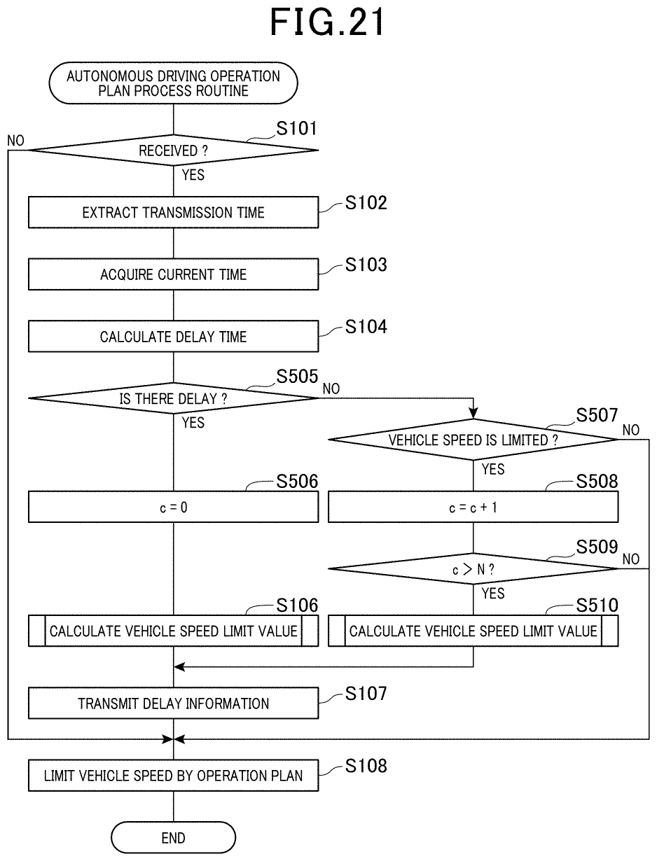

FIG. 21 is a flowchart illustrating an autonomous driving operation plan process routine according to the fifth embodiment. In addition, with regard to the process similar to that of the autonomous driving operation plan process routine according to the first embodiment, the same reference numerals are assigned and detailed description is omitted.

In step S505, the operation plan generator 506 determines whether the delay time is equal to or more than a predetermined threshold value.

If the delay time is equal to or more than the predetermined threshold value (YES in step S505 above), the counter c is set to 0 in step S506, and the process proceeds to step S106.

If the delay time is not equal to or more than the predetermined threshold value (NO in step S505 above), the operation plan generator 506 determines whether the vehicle speed is currently limited to the vehicle speed limit value _{Limit}V₍ₜ₎ in step S507.

If the vehicle speed is not limited (NO in step S507 above), the process proceeds to step S108.

On the other hand, if the vehicle speed is limited (YES in step S507 above), the operation plan generator 506 increments the counter c by 1 in step S508.

In step S509, the operation plan generator 506 determines whether c is larger than a predetermined constant N.

If c is larger than N (YES in step S509 above), the operation plan generator 506 executes the vehicle speed limit value calculation process for setting the vehicle speed limit value _{Limit}V₍ₜ₎ to be large in step S510, and the process proceeds to step S107.

On the other hand, if c is N or smaller (NO in step S509 above), the process proceeds to step S108.

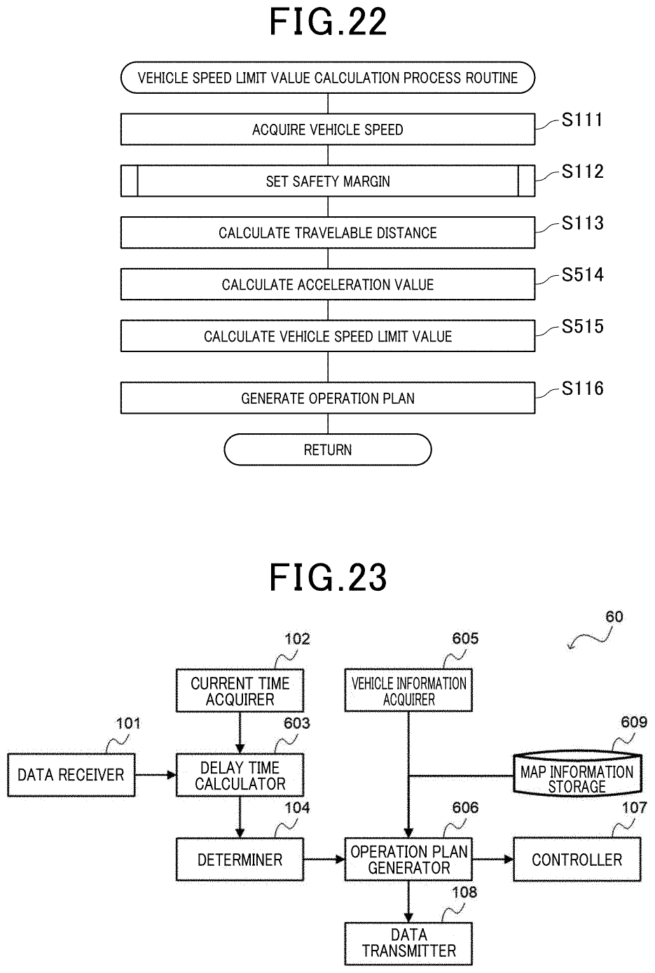

FIG. 22 is a flow chart illustrating a vehicle speed limit value calculation process routine in step S510 above. In addition, with regard to the process similar to that of the vehicle speed limit value calculation process routine according to the first embodiment, the same reference numerals are assigned and detailed description is omitted.

In step S514, the operation plan generator 506 calculates an acceleration value −a₍ₜ₎ for increasing the vehicle speed V₀ as the rate of change of the vehicle speed limit value _{Limit}V₍ₜ₎ on the basis of the calculated travelable distance _{Limit}D₍ₜ₎ and the vehicle speed V₀ acquired in step S111 above.

In step S515, the operation plan generator 506 calculates the vehicle speed limit value _{Limit}V₍ₜ₎ on the basis of the acceleration value −a₍ₜ₎ calculated in step S114 above and the vehicle speed V₀.

As described above, according to the autonomous driving operation planning apparatus of the fifth embodiment of the present disclosure, after setting a vehicle speed limit value to be small, if a delay time calculated a plurality of times is less than a predetermined threshold value, the vehicle speed limit value is set to be large on the basis of the delay time, and an operation plan is generated. It is thereby possible to generate an operation plan for automatically canceling the vehicle speed limit and prevent a behavior such as chattering when the delay time of a communication delay changes drastically.

### <Configuration of Autonomous Driving Operation Planning Apparatus According to Sixth Embodiment of the Present Disclosure>

Next, the configuration of an autonomous driving operation planning apparatus 60 according to a sixth embodiment of the present disclosure will be described. In addition, with regard to the configuration similar to that of the autonomous driving operation planning apparatus 10 according to the first embodiment, the same reference numerals are assigned and detailed description is omitted.

As illustrated in FIG. 23, the autonomous driving operation planning apparatus 60 according to the present embodiment includes the data receiver 101, the current time acquirer 102, a delay time calculator 603, the determiner 104, a vehicle information acquirer 605, an operation plan generator 606, the controller 107, the data transmitter 108, and a map information storage 609.

The delay time calculator 603 estimates an estimated arrival time at which communication data transmitted from the external terminal arrives, and sets a difference between a current time and the estimated arrival time as a delay time.

Specifically, the delay time calculator 603 first estimates the estimated arrival time of the communication data transmitted from the external terminal. The delay time calculator 603 estimates an estimated arrival time at which communication data arrives next time, for example, in the case of communication with an external terminal to which a communication connection has already been established or in the case where an external terminal regularly distributes the communication data. Next, the delay time calculator 603 sets, as a delay time, a difference between a reception time that is a current time acquired from the current time acquirer 102 and the estimated arrival time. Then, the delay time calculator 603 transfers the calculated delay time to the operation plan generator 606.

The vehicle information acquirer 605 acquires the current position of the vehicle. Specifically, the vehicle information acquirer 605 acquires the current position of the vehicle from a position measuring device (not illustrated) such as a GPS mounted on the vehicle. Then, the vehicle information acquirer 605 transfers the acquired current vehicle position to the operation plan generator 606.

The map information storage 609 stores a map including information of vehicle stoppable positions where the communication environment is good.

The operation plan generator 606 performs the same process as that of the operation plan generator 106. In addition, the operation plan generator 606 calculates an allowable delay time that can allow a communication delay, and generates an operation plan so as to stop the vehicle if the communication data has not been not received when an elapsed time from the estimated arrival time exceeds the allowable delay time. Moreover, when generating the operation plan so as to stop the vehicle, the operation plan generator 606 generates an operation plan so as to stop the vehicle at the vehicle stoppable position around the vehicle on the basis of the position of the vehicle and the map.

Specifically, the operation plan generator 606 calculates an allowable delay time that can allow a communication delay. The allowable delay time can be determined in advance depending on the communication method and the type of communication data. Next, the operation plan generator 606 determines whether the delay time is within the allowable delay time. If the delay time is within the allowable delay time, the operation plan generator 606 does not perform a process until a next predetermined timing. This is because if the delay time is within the allowable delay time, it is considered that there is no risk enough to stop the vehicle. On the other hand, when the delay time is not within the allowable delay time, the operation plan generator 606 acquires the map from the map information storage 609. Next, the operation plan generator 606 determines whether there is a location where the communication environment is good near the vehicle on the basis of the current vehicle position and the map. When there is a location where the communication environment is good, the operation plan generator 606 sets the location where the communication environment is good as a stop position where the vehicle is to be stopped. Then, the operation plan generator 606 issues a command to the controller 107 to stop at the stop position. On the other hand, when there is no location where the communication environment is good, the operation plan generator 606 issues a command to the controller 107 to perform an emergency stop with the closest position where the vehicle can stop as the stop position on the basis of the current vehicle position and the map. In addition, the operation plan generator 606 may determine the location where the communication environment is good on the basis of radio field intensity information, as a configuration for acquiring the radio field intensity information in the vicinity.

### <Action of Autonomous Driving Operation Planning Apparatus According to Sixth Embodiment of Present Disclosure>

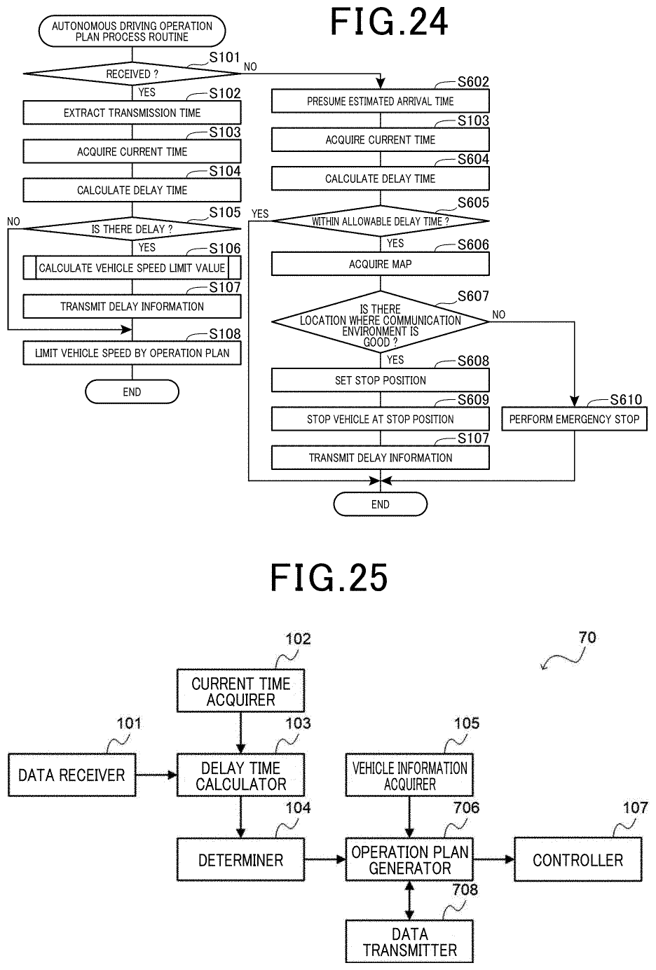

FIG. 24 is a flowchart illustrating an autonomous driving operation plan process routine according to the sixth embodiment. In addition, with regard to the process similar to that of the autonomous driving operation plan process routine according to the first embodiment, the same reference numerals are assigned and detailed description is omitted.

In step S101, if the communication data has not been received (NO in step S101 above), the process proceeds to step S602.

In step S602, the delay time calculator 603 estimates the estimated arrival time of the communication data transmitted from the external terminal.

In step S604, the delay time calculator 603 sets, as a delay time, a difference between a reception time that is a current time acquired from the current time acquirer 102 and the estimated arrival time.

In step S605, the operation plan generator 606 calculates an allowable delay time that can allow a communication delay and determines whether the delay time is within the allowable delay time.

If the delay time is within the allowable delay time (YES in step S605 above), the process ends.

On the other hand, when the delay time is not within the allowable delay time (No in step S605 above), the operation plan generator 606 acquires a map from the map information storage 609 in step S606.

In step S607, the operation plan generator 606 determines whether there is a location where the communication environment is good near the vehicle on the basis of the current vehicle position and the map.

When there is no location where the communication environment is good (NO in step S607 above), the operation plan generator 606 sets the location where the communication environment is good as a stop position where the vehicle is to be stopped in step S608.

In step S609, the controller 107 controls the vehicle to stop at the stop position set in step S608 above.

On the other hand, when there is a location where the communication environment is good (YES in step S607 above), the controller 107 performs an emergency stop with the closest position where the vehicle can stop as the stop position on the basis of the current vehicle position and the map in step S610.

As described above, according to the autonomous driving operation planning apparatus according to the sixth embodiment of the present disclosure, an estimated arrival time at which communication data transmitted from the external terminal arrives is estimated, a difference between a current time and the estimated arrival time is set as a delay time, and an allowable delay time that can allow a communication delay is calculated. If the communication data has not been not received when an elapsed time from the estimated arrival time exceeds the allowable delay time, an operation plan is generated so as to stop the vehicle, and thus when communication is abnormal, the vehicle is stopped early, thereby preventing the vehicle from stopping on a road. Therefore, even if there is a communication delay in autonomous driving with external support, highly safe autonomous driving can be achieved.

In addition, an operation plan is generated so as to stop the vehicle at a vehicle stoppable position around the vehicle on the basis of a map including information of a vehicle stoppable position where the communication environment is good and the position of the vehicle, and highly safe autonomous driving can be thereby achieved even if there is a communication delay in autonomous driving with external support.

### <Configuration of Autonomous Driving Operation Planning Apparatus According to Seventh Embodiment of Present Disclosure>

Next, the configuration of an autonomous driving operation planning apparatus 70 according to a seventh embodiment of the present disclosure will be described. In addition, with regard to the configuration similar to that of the autonomous driving operation planning apparatus 10 according to the first embodiment and the autonomous driving operation planning apparatus 40 according to the fourth embodiment, the same reference numerals are assigned and detailed description is omitted.

As illustrated in FIG. 25, the autonomous driving operation planning apparatus 70 according to the present embodiment includes the data receiver 101, the current time acquirer 102, the delay time calculator 103, the determiner 104, the vehicle information acquirer 105, an operation plan generator 706, the controller 107, and a data transmitter 708.

The data transmitter 708 further transmits an external support request for requesting support information. Then, the data transmitter 708 transfers a transmission time to the operation plan generator 706.

The operation plan generator 706 generates an operation plan so as to stop the vehicle if assumed data assumed for the external support request has not been received by the data receiver 101 by the estimated reception time of the assumed data. Specifically, the operation plan generator 706 determines whether the data receiver 101 has received the assumed data at a predetermined timing. If the assumed data has not been received, the operation plan generator 706 determines whether an estimated reception time can be estimated. For example, when a valid reply time based on a standard established in the support of autonomous driving is set, it can be determined that the estimated reception time can be estimated on the basis of the valid reply time. When the estimated reception time can be estimated, the operation plan generator 706 estimates the estimated reception time. Next, the operation plan generator 706 calculates a difference between the current time and the estimated reception time as the delay time. Next, the operation plan generator 706 calculates the allowable delay time in the same manner as that of the operation plan generator 406. The operation plan generator 706 determines whether the delay time is within the allowable delay time. If the delay time is not within the allowable delay time, the operation plan generator 706 generates an operation plan with the vehicle speed limit value set to 0. Then, the operation plan generator 706 transfers the operation plan to the controller 107.

### <Action of Autonomous Driving Operation Planning Apparatus According to Seventh Embodiment of Present Disclosure>

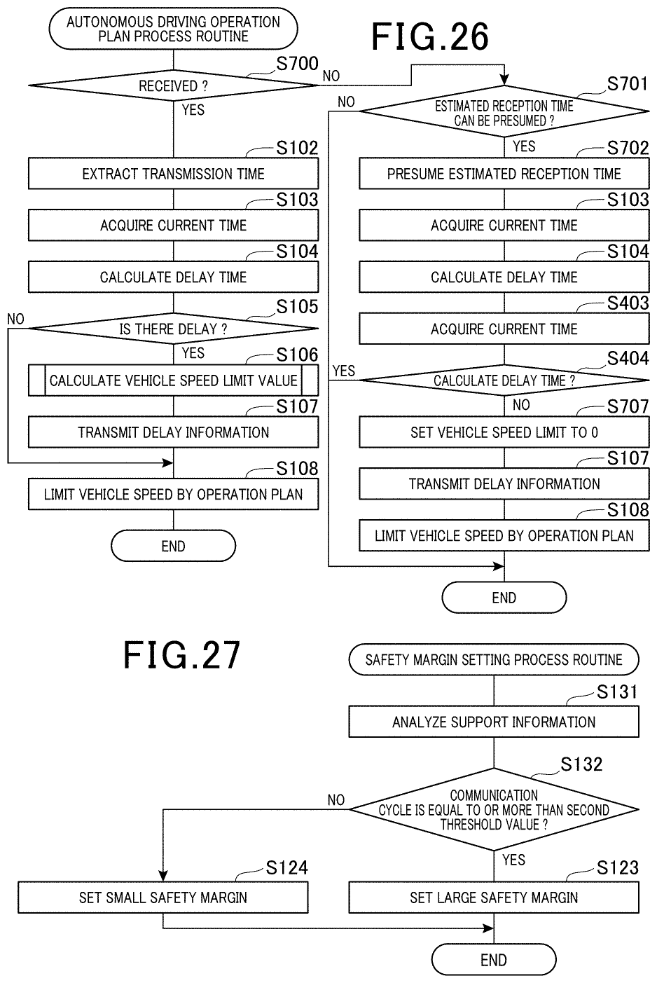

FIG. 26 is a flowchart illustrating an autonomous driving operation plan process routine according to the seventh embodiment. In addition, with regard to the configuration similar to that of the autonomous driving operation plan process routine according to the first embodiment and the autonomous driving operation plan process routine according to the fourth embodiment, the same reference numerals are assigned and detailed description is omitted.

In step S700, the operation plan generator 706 determines whether the data receiver 101 has received the assumed data at a predetermined timing.

If the assumed data has been received (YES in step S700 above), the process proceeds to step S102.

On the other hand, if the assumed data has not been received (NO in step S700 above), the operation plan generator 706 determines whether an estimated reception time can be estimated in step S701.

If the estimated reception time cannot be estimated (NO in step S701 above), the process ends.

If the estimated reception time can be estimated (YES in step S701 above), the operation plan generator 706 estimates the estimated reception time in step S702.

In step S707, the operation plan generator 706 generates an operation plan with the vehicle speed limit value set to 0.

As described above, according to the autonomous driving operation planning apparatus of the seventh embodiment of the present disclosure, an external support request for requesting the support information is transmitted to the external terminal, and if assumed data assumed for the external support request has not been received by the data receiver by the estimated reception time of the assumed data, an operation plan is generated so as to stop the vehicle. Thus, in a highly urgent situation where external support is required, the vehicle can be stopped in a situation where a communication delay is likely to occur before the communication delay occurs. Therefore, even if there is a communication delay in autonomous driving with external support, highly safe autonomous driving can be achieved.

The present disclosure is not limited to the above-described embodiments, and various modifications and applications are possible without departing from the scope of the present invention.

In the above-described embodiment, a case has been described as an example where a plurality of safety margins are set on the basis of whether the support information includes control information. However, the present invention is not limited to this, and may be set on the basis of a communication cycle between the external apparatus and the data receiver 101, for example. FIG. 27 is a flow chart illustrating a safety margin setting process routine when a communication cycle is used.

In step S131, the operation plan generator 106 analyzes the data included in the support information received in step S101 above.

In step S132, the operation plan generator 106 determines whether the communication cycle is equal to or more than a second threshold value set in advance.

If the communication cycle is equal to or more than a second threshold value set in advance (YES in step S132 above), the operation plan generator 106 sets a large safety margin _{long}D_{margin} to the safety margin D_{margin} in step S123.

On the other hand, if the communication cycle is not equal to or more than a second threshold value set in advance (NO in step S132 above), the operation plan generator 106 sets a small safety margin ₛₕₒᵣₜD_{margin} to the safety margin D_{margin} in step S124.

In addition, in the above-described embodiment, each processor is configured as a separate device as the autonomous driving operation planning apparatus, but the present invention is not limited to this, and all the processors may be configured in a same device, for example, an in-vehicle device. Moreover, the configurations of the respective embodiments can be combined.

In addition, the program executed by the CPU reading the software (program) in the above embodiments may be executed by various processors other than the CPU. In this case, as the processor, a dedicated electrical circuit or the like that is a processor having a circuit configuration exclusively designed to execute a specific process, such as a PLD (Programmable Logic Device) whose circuit configuration can be changed after manufacturing such as a FPGA (Field-Programmable Gate Array) and an ASIC (Application Specific Integrated Circuit), is exemplified. Moreover, the autonomous driving operation plan program may be executed by one of these various processors, or a combination of two or more processors of the same type or different types (for example, a plurality of FPGAs and a combination of a CPU and a FPGA). Furthermore, the hardware structure of these various processors is, more specifically, an electric circuit in which circuit elements such as semiconductor elements are combined.

In addition, in each of the abovementioned embodiments, a mode in which the program is stored (installed) in the ROM 12 or storage 14 in advance has been described, but the present invention is not limited to this. The program may be provided in the form of being stored in a non-temporary (non-transitory) storage medium such as a CD-ROM (Compact Disk Read Only Memory), a DVD-ROM (Digital Versatile Disk Read Only Memory), and a USB (Universal Serial Bus) memory. Furthermore, the program may be downloaded from an external apparatus via a network.

With regard to the above embodiments, the following appendixes will be further disclosed.

### (Appendix 1)

An autonomous driving operation planning apparatus mounted on a vehicle for generating an autonomous driving operation plan, the autonomous driving operation planning apparatus comprising:

a memory; and

at least one processor connected to the memory,

wherein the processor is configured to:

receive support information for the autonomous driving of the vehicle from an external terminal by communication;

calculate, by a delay time calculator, a delay time of communication between the external terminal and a data receiver;

if the delay time calculated by the delay time calculator is equal to or more than a predetermined threshold value, set a vehicle speed limit value indicating an upper limit of a speed of the vehicle in such a manner that the vehicle speed limit value becomes smaller as the delay time is longer and that the vehicle speed limit value becomes smaller with a larger change rate as the delay time is longer, and generate the operation plan; and control the vehicle by autonomous driving on a basis of the generated operation plan.

### (Appendix 2)

A non-transitory storage medium storing an autonomous driving operation planning program used in an autonomous driving operation planning apparatus mounted on a vehicle for generating an autonomous driving operation plan, the autonomous driving operation planning program for causing a computer to:

receive support information for the autonomous driving of the vehicle from an external terminal by communication;

calculate, by a delay time calculator, a delay time of communication between the external terminal and a data receiver;

if the delay time calculated by the delay time calculator is equal to or more than a predetermined threshold value, set a vehicle speed limit value indicating an upper limit of a speed of the vehicle in such a manner that the vehicle speed limit value becomes smaller as the delay time is longer and that the vehicle speed limit value becomes smaller with a larger change rate as the delay time is longer, and generate the operation plan; and

control the vehicle by autonomous driving on a basis of the generated operation plan.

### CONCLUSION

An object of the present disclosure is to provide an autonomous driving operation planning apparatus, an autonomous driving operation planning method, and an autonomous driving operation planning program that can achieve highly safe autonomous driving even if there is a communication delay in autonomous driving with external support.

An autonomous driving operation planning apparatus according to the present disclosure is an autonomous driving operation planning apparatus mounted on a vehicle for generating an autonomous driving operation plan and includes: an operation plan generator configured to generate an operation plan by autonomous driving of the vehicle; a controller configured to control the vehicle by autonomous driving on a basis of the operation plan generated by the operation plan generator; a data receiver configured to receive support information for the autonomous driving of the vehicle from an external terminal by communication; and a delay time calculator configured to calculate a delay time of communication between the external terminal and the data receiver. If the delay time calculated by the delay time calculator is equal to or more than a predetermined threshold value, the operation plan generator sets a vehicle speed limit value indicating an upper limit of a speed of the vehicle in such a manner that the vehicle speed limit value becomes smaller as the delay time is longer and that the vehicle speed limit value becomes smaller with a larger change rate as the delay time is longer, and generates the operation plan.

In addition, an autonomous driving operation planning method according to the present disclosure is an autonomous driving operation planning method used in an autonomous driving operation planning apparatus mounted on a vehicle for generating an autonomous driving operation plan, and includes: generating, by an operation plan generator, an operation plan by autonomous driving of the vehicle; controlling, by a controller, the vehicle by autonomous driving on a basis of the operation plan generated by the operation plan generator; receiving, by a data receiver, support information for the autonomous driving of the vehicle from an external terminal by communication; and calculating, by a delay time calculator, a delay time of communication between the external terminal and the data receiver. If the delay time calculated by the delay time calculator is equal to or more than a predetermined threshold value, the operation plan generator sets a vehicle speed limit value indicating an upper limit of a speed of the vehicle in such a manner that the vehicle speed limit value becomes smaller as the delay time is longer and that the vehicle speed limit value becomes smaller with a larger change rate as the delay time is longer, and generates the operation plan.

Furthermore, an autonomous driving operation planning program according to the present disclosure is an autonomous driving operation planning program used in an autonomous driving operation planning apparatus mounted on a vehicle for generating an autonomous driving operation plan, and is a program for causing a computer to execute a process including: generating, by an operation plan generator, an operation plan by autonomous driving of the vehicle; controlling, by a controller, the vehicle by autonomous driving on a basis of the operation plan generated by the operation plan generator; receiving, by a data receiver, support information for the autonomous driving of the vehicle from an external terminal by communication; and calculating, by a delay time calculator, a delay time of communication between the external terminal and the data receiver. If the delay time calculated by the delay time calculator is equal to or more than a predetermined threshold value, the operation plan generator sets a vehicle speed limit value indicating an upper limit of a speed of the vehicle in such a manner that the vehicle speed limit value becomes smaller as the delay time is longer and that the vehicle speed limit value becomes smaller with a larger change rate as the delay time is longer, and generates the operation plan.

According to the autonomous driving operation planning apparatus, autonomous driving operation planning method, and autonomous driving operation planning program of the present disclosure, even if there is a communication delay in autonomous driving with external support, highly safe autonomous driving can be achieved.

What is claimed is:

1. An autonomous driving operation planning apparatus mounted on a vehicle for generating an autonomous driving operation plan, the autonomous driving operation planning apparatus comprising:
an operation plan generator configured to generate an operation plan by autonomous driving of the vehicle;
a controller configured to control the vehicle by autonomous driving on a basis of the operation plan generated by the operation plan generator;
a data receiver configured to receive support information for the autonomous driving of the vehicle from an external terminal by communication; and
a delay time calculator configured to calculate a delay time of communication between the external terminal and the data receiver,
wherein if the delay time calculated by the delay time calculator is equal to or more than a predetermined threshold value, the operation plan generator sets a vehicle speed limit value indicating an upper limit of a speed of the vehicle in such a manner that the vehicle speed limit value becomes smaller as the delay time is longer and that the vehicle speed limit value becomes smaller with a larger change rate as the delay time is longer, and generates the operation plan.

2. The autonomous driving operation planning apparatus according to claim 1, further comprising a vehicle information acquirer configured to acquire the speed of the vehicle, wherein if a communication delay occurs, the operation plan generator calculates a travelable distance that the vehicle can travel safely on a basis of an operator monitoring distance that is a distance where a periphery of the vehicle can be monitored by the external terminal, a delay distance that is a distance traveled by the vehicle in accordance with the speed of the vehicle during the delay time, and a safety margin set in advance, calculates a deceleration value required to stop at the travelable distance on a basis of the travelable distance and the speed of the vehicle, and calculates the vehicle speed limit value on a basis of the speed of the vehicle and the deceleration value.

3. The autonomous driving operation planning apparatus according to claim 1, wherein when the support information includes data related to control of autonomous driving, the operation plan generator sets the vehicle speed limit value in such a manner that the vehicle speed limit value becomes smaller with a larger change rate as the delay time is longer.

4. The autonomous driving operation planning apparatus according to claim 1, wherein the operation plan generator sets the vehicle speed limit value in such a manner that the vehicle speed limit value becomes smaller with a larger change rate as the delay time is longer, as a communication cycle of the data receiver is shorter.

5. An autonomous driving operation planning apparatus mounted on a vehicle for generating an autonomous driving operation plan, the autonomous driving operation planning apparatus comprising:
an operation plan generator configured to generate an operation plan by autonomous driving of the vehicle;
a controller configured to control the vehicle by autonomous driving on a basis of the operation plan generated by the operation plan generator;
a data receiver configured to receive support information for the autonomous driving of the vehicle from an external terminal by communication; and
a delay time acquirer configured to acquire a delay time predicted on a basis of a travel route on which the vehicle has traveled and past travel data including a delay time of communication between the external terminal and the data receiver during the traveling,
wherein if the delay time acquired by the delay time acquirer is equal to or more than a predetermined threshold value, the operation plan generator sets a vehicle speed limit value indicating an upper limit of a speed of the vehicle in such a manner that the vehicle speed limit value becomes smaller as the delay time is longer and that the vehicle speed limit value becomes smaller with a larger change rate as the delay time is longer, and generates the operation plan.

6. The autonomous driving operation planning apparatus according to claim 5,
wherein the data receiver receives the delay time calculated by the external terminal, and
wherein the delay time acquirer acquires the delay time received by the data receiver.

7. The autonomous driving operation planning apparatus according to claim 1,
wherein the external terminal is another vehicle traveling in front of the vehicle, and
wherein the data receiver receives delay information including the delay time acquired by the other vehicle.

8. The autonomous driving operation planning apparatus according to claim 1,
wherein the delay time calculator estimates an estimated arrival time at which communication data transmitted from the external terminal arrives, and sets, as a delay time, a difference between a reception time at which the data receiver actually receives the communication data and the estimated arrival time, and
wherein the operation plan generator further calculates an allowable delay time that can allow a communication delay, and sets the vehicle speed limit value and generates the operation plan if the communication data has not been not received when an elapsed time from the estimated arrival time exceeds the allowable delay time.

9. The autonomous driving operation planning apparatus according to claim 8, wherein after setting the vehicle speed limit value to be small, if the delay time calculated a plurality of times by the delay time calculator is less than the predetermined threshold value, the operation plan generator sets the vehicle speed limit value to be large on a basis of the delay time, and generates the operation plan.

10. The autonomous driving operation planning apparatus according to claim 2,
wherein the delay time calculator estimates an estimated arrival time at which communication data transmitted from the external terminal arrives, and sets, as a delay time, a difference between a current time and the estimated arrival time, and
wherein the operation plan generator further calculates an allowable delay time that can allow a communication delay, and generates the operation plan so as to stop the vehicle if the communication data has not been not received when an elapsed time from the estimated arrival time exceeds the allowable delay time.

11. The autonomous driving operation planning apparatus according to claim 10, further comprising a map information storage configured to store a map including information of a vehicle stoppable position where the communication environment is good,
wherein the vehicle information acquirer further acquires a position of the vehicle, and
wherein when generating the operation plan so as to stop the vehicle, the operation plan generator generates the operation plan so as to stop the vehicle at the vehicle stoppable position around the vehicle on a basis of the position of the vehicle and the map.

12. The autonomous driving operation planning apparatus according to claim 2, further comprising a data transmitter configured to transmit to the external terminal an external support request for requesting the support information, wherein the operation plan generator generates the operation plan so as to stop the vehicle if assumed data assumed for the external support request has not been received by the data receiver by the estimated reception time of the assumed data.

13. An autonomous driving operation planning method used in an autonomous driving operation planning apparatus mounted on a vehicle for generating an autonomous driving operation plan, the autonomous driving operation planning method comprising:
generating, by an operation plan generator, an operation plan by autonomous driving of the vehicle;
controlling, by a controller, the vehicle by autonomous driving on a basis of the operation plan generated by the operation plan generator;
receiving, by a data receiver, support information for the autonomous driving of the vehicle from an external terminal by communication; and
calculating, by a delay time calculator, a delay time of communication between the external terminal and the data receiver,
wherein if the delay time calculated by the delay time calculator is equal to or more than a predetermined threshold value, the operation plan generator sets a vehicle speed limit value indicating an upper limit of a speed of the vehicle in such a manner that the vehicle speed limit value becomes smaller as the delay time is longer and that the vehicle speed limit value becomes smaller with a larger change rate as the delay time is longer, and generates the operation plan.

14. An autonomous driving operation planning program used in an autonomous driving operation planning apparatus mounted on a vehicle for generating an autonomous driving operation plan, the autonomous driving operation planning program stored in a non-transitory tangible computer-readable media for causing a computer to execute a process including:
generating, by an operation plan generator, an operation plan by autonomous driving of the vehicle;
controlling, by a controller, the vehicle by autonomous driving on a basis of the operation plan generated by the operation plan generator;
receiving, by a data receiver, support information for the autonomous driving of the vehicle from an external terminal by communication; and
calculating, by a delay time calculator, a delay time of communication between the external terminal and the data receiver,
wherein if the delay time calculated by the delay time calculator is equal to or more than a predetermined threshold value, the operation plan generator sets a vehicle speed limit value indicating an upper limit of a speed of the vehicle in such a manner that the vehicle speed limit value becomes smaller as the delay time is longer and that the vehicle speed limit value becomes smaller with a larger change rate as the delay time is longer, and generates the operation plan.
